(19) United States
(12) Patent Application Publication
(10) Pub. No.: US 2021/0233024 A1
(43) Pub. Date: Jul. 29, 2021

(54) AGGREGATING DATA OF USER PREFERENCES FOR REQUESTED SERVICES, MATCHING AND PROVIDING REQUESTED SERVICES

(71) Applicant: Rohan Vishnubhai Patel, Bensalem, PA (US)

(72) Inventor: Rohan Vishnubhai Patel, Bensalem, PA (US)

(21) Appl. No.: 17/228,626

(22) Filed: Apr. 12, 2021

Related U.S. Application Data
(60) Provisional application No. 63/009,407, filed on Apr. 13, 2020.

(51) Int. Cl. G06Q 10/08; G06Q 10/04

(52) U.S. Cl. CPC G06Q 10/08345; G06Q 10/047; G06Q 10/08355

(57) ABSTRACT

A mapping method that matches customer service requests with the service providers. The Service providers share trip details, preferred costs for additional time/distance required to be traveled reach the service destination, and fulfill the customer service requests during the trip. The service providers can set multiple parameters in combination with the additional time/distance deviations from the trip schedule. The additional travel time/distance is calculated based on the estimated traffic, route availabilities at the time of the trip. The trip parameters also can be extracted from navigation applications such as a Google map and receive a service request based on additional time/distance preferences.

### CROSS-REFERENCE TO RELATED APPLICATIONS

The present application claims priority of provisional application 63/009,407 filed on Apr. 13, 2020 disclosures of which are incorporated herein at least by reference.

### BACKGROUND OF THE INVENTION

### Field of the Invention

The present invention is in field of onsite services, transportation services, aggregation of preferences of service providers coupled with preferred costs and location services.

### Description of Related Art

Onsite services and transportation services historically been executed through a variety of service providers and transportation services respectively. The service providers travel to the onsite to perform services. The transportation services are fulfilled by the private entities presently wherein the private entities have drivers or service providers transferring the packages from one location to another. Delivery service is executed by a variety of service providers wherein a parcel is picked up from a store or a restaurant and delivered to the desired location. The onsite services compensate the service provider for the work they do at the site but do not consider the additional time that gets consumed travelling to the site and back to the desired location of the service provider. If a service provider is given additional travelling time along with the onsite service request details and offered cost, the service provider will be able to accept onsite service requests more efficiently. The delivery services provide details of the pickup location, the delivery location; estimated travel distance, and compensation amount and give the same information to all the service providers in the area. There is a need for a data mapping system that calculated the service provider's time/distance to the pickup location, travel time/distance between the pickup location to delivery location, and travel time/distance from delivery location back to the desired location. If the service providers can these parameters then they will be able to make a more rational decision in choosing the service requests more efficiently. The service providers are travelling at any given time so if a system uses their current/planned location and couple it with the cost being offered, the service providers can set parameters to be alerted only when the service request matches their parameters.

Implementation of a data aggregation system that provides the service provider ability to set a combination of preferences including but not limited to additional travel time/distance and the compensation for the additional travel time/distance that needed to be traveled to fulfill the service request.

### BRIEF SUMMARY OF THE INVENTION

The main object of the present invention is to create a data aggregation system for a customer and a service provider. The customer sends a request for a service or plurality of services associated with at least a geographical location, the customer preferences, schedule preferences, and a preferred cost option.

For purpose of disclosure, a “customer” maybe anyone who requests services associated with at least a geographical location. The service request of the customer can be an onsite service at one geographical location or a transportation request between at least two geographical locations. The onsite service can be any kind of services that are performed at a site such as landscaping services, cleaning services, maintenance services, equipment or appliance repair service, a plumbing service, purchasing an entry ticket for a park or a venue or a theater, picking up a product from a store's shelf, an HVAC repair service, a construction service, a machinery repair service, an emergency repair service of any kind that are performed at one location. The transportation service can be anything that is being transported between at least two geographical locations that include a package, an item from a store delivered to at least a location, a food parcel delivered from one place to another, a person transported from one location to another. The package can be anything from a small size load that requires a car to a bulk size load that requires a box truck or a container to transport. The transportation service between two locations uses any commercial, non-commercial, small, bulky goods or items including transportations of a person between two geographical locations.

For purpose of disclosure, a “service provider” is intended to mean anyone who fulfills at least the service requested by the customer. A service provider also can be the customer and the customer also can be the service provider at any given time. A service provider can be an entity or anyone who fulfills the service requests of a customer or another entity. An “additional time” will be any or all of the travel time required to reach the geographical location of the customer service request, fulfill the customer service request and return to the route to continue with the trip of the service provider. Additional time is any additional time, the service provider anticipates spending on top of the trip's estimated travel time, to fulfill the customer service request. The additional time will be estimated for the current or the future trips considering parameters such as traffic, weather, route of travel, and the service provider preferences for routes at the time of the trip schedule. The additional travel time will be estimated based on many parameters that affect the service provider's additional time required to reach at least one geographical location to fulfill the customer request. The trip can be fulfilled by driving a personal vehicle, commercial vehicle, or by travelling through public or private transportation services. ex. Train, a bus, a boat, a plane, etc. Each of the service providers herein also can be a driver who is driving a personal or a commercial vehicle and also a service provider.

The mapping server system receives inputs from a user and evaluates those inputs. The mapping server system stores the customer service request parameters into a first database and the service provider preferences into a second database. A Monitor server monitors weather, traffic, tracking of public or private transport services, and at least a tracking number. The Monitor server will be providing data in real-time to the mapping server. A tracking server tracks GPS locations shared by at least a service provider and at least a customer in real-time and location data will be used by the mapping server. Both a customer and a service provider register themselves and sets up their preferences. The mapping server receives at least a customer configured preferences that include but are not limited to at least a customer preferred cost/range of a cost for at least a service request, a plurality of scheduled service times, at least a geographical location. The server system stores the customer preferences in a first database.

The server system receives at least a service provider configured preferences that include but not limited to live sharing of the current location of the service provider, at least a current/future scheduled trip details including a schedule associated with at least two GPS locations, and the service provider preferred cost for the service provider pre-determined acceptable change in the scheduled trip details to fulfill the service provider preferred at least a service; wherein the service provider configured preferences are adjustable by the service provider, wherein the service provider shares preferences for an acceptable change in the trip details. The acceptable change in the trip details is an additional distance and/or additional time to fulfill the service and/or an additional travel time and/or a change in the schedule required to fulfill the service provider preferred service, wherein the service provider preferred cost is for the additional distance and/or the additional time to fulfill the service and/or the additional travel time and/or the change in the schedule. The server system stores the service provider preferences in a second database.

A mapping server compares the preferences of the first database and the second database and if a match is found, generates at least a trip details and the service provider preferred cost and preferences that can fulfill the service request of the customer at the customer preferred cost; The mapping server then alerts the service provider who then can accept and fulfill the customer service request accordingly.

The tracking server, in response to receiving the service provider, preferred schedule and preferred cost generates a GPS location of the service provider, generates services to be fulfilled within the predetermined proximity based on services to be fulfilled within the proximity based on the service provider criteria and predetermined additional time and/or distance based on the mapping. The mapping server sends alerts to the service provider during the service provider preferred schedule for services nearby based on the additional distance and/or the additional time to fulfill the service and/or the additional travel time and/or the change in the schedule parameters set for the preferred service (category) and get paid through a mobile application or though pre-determined payment services or by the customer.

The service provider can be in a store, wherein if a request comes for delivery of an item from the store/nearby to a delivery address, based on the parameters set by the service provider, if the delivery address falls into preferences and proximities set by the service provider within the trip (from the store to house address) then the service provider is notified. The service provider then can accept and fulfill the customer service request very efficiently. A service provider can be travelling nationally or internationally using public transportation or private transportation and fulfill a customer request and make additional cash on the go.

The service provider additionally sets parameters wherein the service provider is willing to change the route of travel between the two GPS locations of the trip and fulfill the customer service requests as long as the customer preferred cost satisfies the additional time and/or distance it takes for the service provider to fulfill the customer service request. Fulfilling customer services during the trip between two geographical locations during the service provider's current or planned trip saves time and energy for the service provider because the service provider already making the trip for himself/herself. Thus, the service provider can fulfill the customer's service request at a substantially lower cost and still make sufficient income since the service provider is not making a special trip to fulfill the service. A service provider can also be a driver who drivers a personal or commercial vehicle for the current or the planned trip. The embodiment herein relates to a service provider sharing trip details and receives alerts to fulfill customer requests. The service provider sets parameters to limit additional travel time/distance with a preferred cost from the route of the planned trip in conjunction with a preferred cost to make the job worthwhile. The parameters set by the customer and the service provider can have multiple sets of combinations, multiples preferences of the preferred cost, each for additional travel time/distance at the time of the trip schedule.

Examples of the service provider set preferences also can be:

for up to 10 min. additional travel time >offered compensation must be more than X for up to 20 min. additional travel time >offered compensation must be more than 1.4× a customer with 5 star rating >service provider set parameters to be 100% or X amount;
a customer with 4 star rating >service provider set parameters to be 110% or 1.1×;
a customer with 3 star rating >service provider set parameters to be 120% or 1.2×;
a customer with 1 star rating >service provider set parameters to be 150% or 1.5×;
$5 for 2 (miles) units of additional travel distance (for pickup and/or drop off or both);
20$ for 10 (miles) units of additional travel distance (on top of planned trip distance);
$5 for 2 (miles) units of additional travel distance for a sedan car of the service provider;
$10 for 2(miles) units of additional driving distance for a minivan of the service provider;

The service provider may have multiple types of vehicles, wherein the service provider registers all vehicles into the system. If any of the customer service requests require any specific vehicle, the mapping server will notify the service provider to drive that specific vehicle for the service provider's scheduled trip and fulfill the customer service request. The service provider can have different preferences set for different vehicle types or transportation methods. The service provider can be travelling from NY city to DC and picks up a parcel from Edison, N.J., and delivers it to Philadelphia as per customer request. The service provider can set parameters for the change in the scheduled trip in conjunction with the offered money. Each of the service providers can set their preferences for money they prefer for the same customer service request. Each of the customers can offer a different amount of money for the same request. The mapping system also can be programmed to intervene and offer the customer a range of preferred amounts to be offered for a specific type of service and prevent customers from offering too little or too much.

If specific categories of services are specified, the meaning of “service provider” would be limited as required by the categories. A service provider registers, set preferences, uploads credentials for their certifications, and shares details about a current or a future trip.

### BRIEF DESCRIPTION OF THE SEVERAL VIEWS OF THE DRAWINGS

FIG. 1 illustrates a non-limiting embodiment of an overview of the mapping process

FIG. 2 illustrates a non-limiting embodiment of a customer service request award distribution to a matching service provider

FIG. 3 illustrates a non-limiting embodiment of a service provider preferred route of travel and in-route available customer service request

FIG. 4 illustrates an onsite customer service request within a route of travel of a service provider

FIG. 5 illustrates a two service provider's gps locations in comparison to a delivery service request from a store to a delivery address

### DETAILED DESCRIPTION OF THE INVENTION

### Overview

An automated mapping system is configured to accept service requests from customers and distribute them to service providers. In doing so, the service providers are allowed to set preferences based on their preferences to set different parameters, preferred costs for the same customer service request. In other words, service providers are alerted only if the parameters and the customer preferred cost to match the service provider set parameters and the service provider preferred cost.

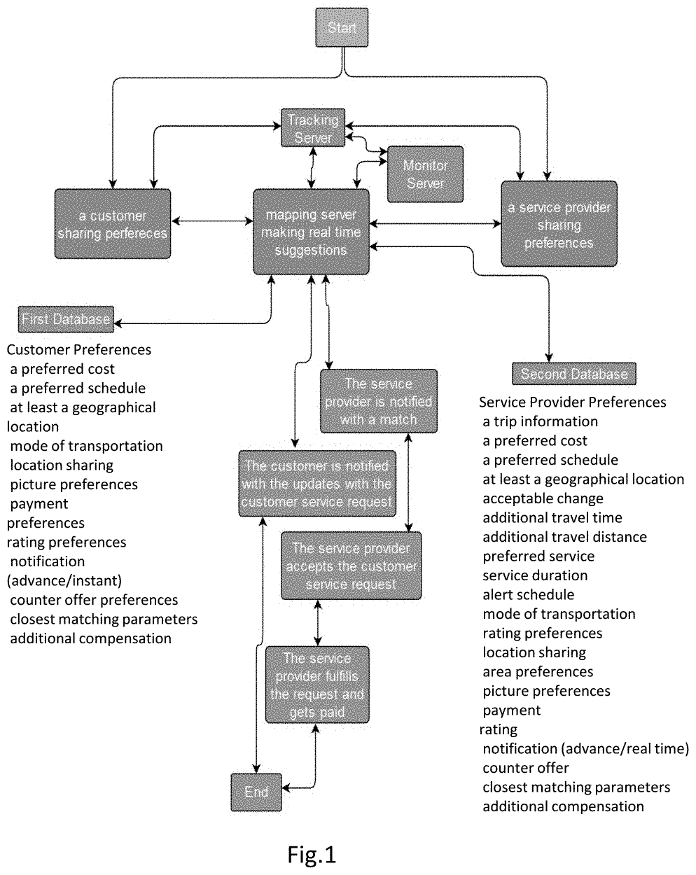

As shown in FIG. 1 a user can be a customer or a service provider, wherein “a customer” is anyone who puts a request for a customer service request to be fulfilled. The customer also may offer a preferred cost, preferred service schedule time, and at least a geographical location associated with the customer service request. “A service provider” is anyone who fulfills the customer service request. The service provider may prefer to be paid for fulfilling the customer service request. The service provider also can be a driver or a passenger or may not even travel to fulfill a customer service request but arrange fulfillment of the customer service request. Both the customer and the service provider share their preferences into the mapping server using a mobile phone or an internet-enabled device. A mobile application or a website can be used to share preferences to and/or receive notifications from the mapping server.

The customer sharing preferences can include a detail of the service request, wherein the service request can be fulfilled onsite or by transportation between two geographical locations. The customer shares preferences explaining the nature of the customer service request, at least a geographical location for onsite service or at least two geographical locations for transportation service, a preferred cost, and a preferred schedule. The customer may offer one of the preferred costs for the first scheduled times and another of the preferred costs for the second schedule times. The customer may offer a pre-determined amount of preferred cost for the service request to be fulfilled before a first set of scheduled service times and a different pre-determined amount of preferred cost for the service request to be fulfilled after a first set of schedule or a second set of a schedule. The customer also can set predetermined parameters for the additional compensation, wherein if the predetermined parameters are met, the service provider receives additional compensation offered by the customer. The customer shares preferences of a mode of transportation or a vehicle for the service provider. If a bulkier item needs to be transported or delivered from a store to an address, the customer sets parameters for the mapping server to alert only service providers with a minivan or appropriate vehicle. The customer shares preferences wherein an item needs to be transported from New York City to London, wherein the mapping server alerts only appropriate service providers who have scheduled their trips from New York City to London during the customer preferred schedule times. The customer shares location sharing preferences with the mapping server, wherein the location preferences can be for the customer, who shares location details with a preferred service provider. The location sharing preferences also can be set for the preferred service provider demanding location sharing requirements at least during the fulfillment of the customer service request. The customer shares a picture preference to the mapping server, wherein a preferred service provider needs to have a profile picture as a requirement for one of the mapping criteria. The customer shares their profile picture with a preferred service provider. The customer shares a picture preference where a preferred service provider is required to take at least a picture during the onsite service request or transport service request. A service provider requests pictures to be taken during a pickup and a drop off of the transported item and/or a picture with a geographical location linked to each of the pictures taken by the service provider. The service provider request a picture approval process wherein the service provider takes a picture, uploads it, the customer approves it then only the service provider moves ahead with the process of transporting the item, at the delivery location, the customer and/or the service provider required to take pictures, upload online to end the fulfillment of the customer service request. The customer shares parameters where the service provider is required to take a picture of a person who has released the item, the person required to take a picture of the service provider at the release of the item, the service provider is required to take a picture at the delivery location of the location or the delivery accepting party, delivery accepting party is required to take a picture of the service provider.

The customer shares a payment preference where the customer pays in advance or at end of the customer service request fulfillment, pay in advance or send payment through using a third party money remittances systems such as PayPal or western union. The customer shares preferences and sends money to the service provider, wherein the service provider is anticipated to buy something with cash for the customer. The customer shares rating preferences wherein the customer offers a different sum of money based on a pre-determined rating of a preferred service provider, wherein the customer offers more money for a predetermined (higher) rating preferences vs lesser money to a second predetermined (lower) rating preferences of a preferred service provider. The customer shares notification preferences where the customer is notified in advance when the service provider is nearby the at least one geographical location of the customer service request. For the transportation service, it helps the pick-up location (first geographical location) to keep the item ready to be transported for the service provider, saves the service provider's valuable time, and notifies receiving party in advance before the service provider reaching to the delivery spot (second geographical location). The advance alert notification preferences are set by the customer, where the mapping server maps the live location of the service provider and notify in advance considering traffic, weather, or any other parameters that affect the service provider's travel duration to the pickup or the drop off location.

The customer share preferences for a counteroffer for the customer preferred cost, the customer preferred schedule, and the customer preferred at least a geographical location. The counter-offer of the preferred cost is offering 2nd counteroffer for the customer preferred cost to get the service fulfilled within a predetermined schedule or a 2nd preferred customer schedule preferences if the first preferred schedule requirement cannot be met. The customer shares at least a proximity wherein if no service provider can travel to a pick-up or a drop-off geographical location, the customer offers to arrange to have an item transported in preferred proximities for the pickup and/or drop-off geographical area preferences to find a preferred service provider. The customer shares any combination of the customer preferred cost, the customer preferred schedule, and the customer preferred at least a geographical location and a second set of preferences if the first set of preferences are not satisfied by the mapping server.

The customer shares preferences for closest matching parameters, wherein even if the service provider's preferences are not completely matching with the customer preferences, the customer can find the closest matching service provider parameters and adjust parameters that get the matching preferences fulfilled and the mapping server finds the service provider and gets the customer service request fulfilled. The customer offers additional compensation for the customer service request, wherein the additional compensation is tied to a schedule or any of the customer pre-determined preferences, wherein if the service provider satisfied the preferences for the additional compensation, the mapping server automatically awards the additional compensation to the service provider in the predetermined amount and preferences set by the customer.

The service provider shares preferences with the mapping server which then is store in the second database. The service provider preference consists of trip information between at least two GPS locations, at least a preferred schedule, and at least a preferred cost preference. The trip information can be a current trip or a future trip that includes at least two GPS locations and can be completed as a driver, a passenger, or an organizer who organizes the transportation of goods between two GPS locations without actually going with the transport vehicle. The trip also can be a trip within the country or an international trip wherein the service provider uses a personal or public or private means of transportation. The service provider preferred cost is an amount or a range of an amount for a service provider preferred at least a service type. The service provider combines the service provider preferred cost with the additional time required to reach a preferred set of at least a service, perform the service, time to return to the route, and continue the trip (total estimated additional time).

For ex. If a trip from newyork city to Philadelphia takes 3 hours for the service provider preferred schedule based on the traffic and route preferences and providing a customer onsite/transport service request in-route delays the estimated arrival time in the philadelphia by 30 mins, the the service provider shares preferences for additional time and combines it with a preferred cost.
So for a service that takes <30 min.s to fulfill >preferred cost is 25 USD;

A service that takes 31-60 min.s to fulfil >preferred cost is 65 USD.

The system allows the service provider set a preferred cost or provides range of preferred costs for a set range of (estimated) additional time at the time of a trip schedule.
The service provider combines the service provider preferred cost with the total additional distance needs to be travelled to reach preferred set of at least a service and distance to return back to the route and continue trip.
For ex. If a trip from newyork city to Philadelphia is of 120 miles, and the service provider needed to travel additional 10 miles to fulfill a preferred customer service request (on site service or transport service between two geographical locations) then the service provider combines preferences for additional distance with a preferred cost.
So for a service that takes <10 miles to fulfill >preferred cost is 25 USD ;

A service that takes 11-20 miles to fulfill >preferred cost is 40 USD.

The service provider also can combine an additional time with additional distance and set preferred cost preferences based on the combination of the two. Time is money and distance costs money to travel so by combining the additional time preferences with preferred cost or additional distance with preferred cost or a combination of additional time and additional distance with a preferred cost, the service provider can make sure to make a decent amount of money for the customer service requests he/she is alerted for.

The service provider shares a live location to the tracking server, a preferred set of at least a service, proximity of a preferred set of the service, and a preferred cost, wherein the customer is alerted by the available jobs that match the service provider criteria. The jobs might be customer service requests for cleaning snow in surrounding proximities (set by the service provider) or any onsite job that's been shared by a preferred customer. Service provider sharing live location gets an alert when the service provider's GPS location changes asking if the provider is going home or elsewhere. And the mapping for a server provider preferred customer service requests to the service provider. A service provider shares live location during the service provider preferred schedule, and is present at a store, the mapping server gets a service request for a geographical location close to that store, and the mapping server alerts the service provider if the pickup and drop off location falls within the set criteria of the service provider. The mapping server asks the service provider if he/she is going home, and schedule from that location, and alert with a service request that can be fulfilled on way home from the store location. Similarly, customers or business entities can put requests for their parcels to be picked up by service providers/entities to be delivered at the respective locations. Multiples of a service provider also can be used to fulfill one service request wherein the first service provider fulfills part of the customer service request and at least another service provider fulfills the rest of the customer service request.

A service provider shares preferences of what kinds of services he/she prefers to be alerted for. A professional service provider may choose specific preferred types of customer service requests to be sent. A business or entity may choose only certain types of customer service requests to be alerted for. A service provider also can opt for service types that he/she does not prefer to be alerted for.

The service provider shares preferences to be alerted that are based on their preferred schedule, geographical area of preference, geographical area to be not alerted for, customer rating requirement (lower than predetermined rating) to be alerted for or not to be alerted for, preferred or not preferred at least a service. The customer shares a pre-determined preferred cost that is based on the schedule of a day. The same service may have different predetermined preferred costs during the daytime and a different predetermined preferred cost at night time. The same service may have lower cost parameters set based on review ratings of the customer. The same service may have a pre-determined cost preference based on the geographical area of preference. The customer also can tie up a pre-determined preferred cost for each of the vehicles needed to be driven for the fulfillment of a customer service request. The customer shares a lower preferred cost for a small vehicle with a service request of food delivery or a small parcel delivery than a customer service request that requires the service provider to drive a larger vehicle.

The service provider sets a pre-determined preferred cost based on a review rating of a customer. The service provider sets pre-determined preferred cost different for each of pre-determined review rating/range of ratings of a customer. A service provider may charge more for customers with lower review ratings or wise versa. The service provider may prefer to be alerted only for service request by pre-determined review ratings of a customer, wherein a service provider may set preferences to be alerted for only 5-star review rating customers and another service provider may want to serve just low star review rating customers at a higher preferred cost than usual.

The service provider shares preferences where the service provider can decline all customer service requests that require a location of the service provider to be shared with the customer. The service provider can opt-out from sharing the location to the tracking server and a customer or opt-out from sharing location with just a customer but allows location sharing with the tracking server or may opt-in for sharing location details to all. Location sharing also can be used to alert the customer when the service provider is approaching one or at least two geographical locations to fulfill the customer service request. The service provider also can demand to be alerted only for customer requests that will be sharing the customer's location with the service provider all the time or at least once during the fulfillment of the customer service request.

The service provider shares picture preferences wherein the service provider shares own profile and may demand a customer's picture to be present on a customer profile to be alerted for a service request of that customer. The service provider shares parameters wherein the service provider will only fulfill (to be alerted) or prefer not fulfill (not to be alerted) customer services that require at least a picture taken and uploaded during the time of fulfilling the customer service request.

The service provider shares payment preferences, wherein the preferences may include advance payment, payment through a mobile application, payment through third party services such as PayPal, western union, or a cash payment from a customer. The service provider may set alert parameters to be alerted only if a customer request matches payment preferences of the service provider's payment preferences.

The service provider shares preferences where every customer service request alerted for shows at least a few recent reviews of a customer and/or at least a few recent reviews left for other service providers by the customer. The service provider can make a decision or set parameters to filter out and serve at least a customer that fits the service provider's preferences.

The service provider sets parameters to send a notification to the pickup/drop off/a customer's at least a geographical location before pre-set interval set by the service provider, wherein the tracking server tracks the location of the service provider and alerted when estimated arrival time to the pickup/drop-off/the customer's at least a geographical location to save time so the service request can be fulfilled more efficiently.

The service provider shares preferences for closest matching preferred service request wherein the closest matching preferred service requests are stored in the service provider's account, wherein the service provider can review the parameters that are not matching and accept the request if wishes or change the parameters for other future customer service requests too. The service provider also can set mild alerts or customize alerts for the close matching parameters and differentiate them from the complete matching service requests.

The service provider can set preferences to set alert preferences for any customer request with an additional compensation amount offer that falls into preferences or with close parameters, wherein the service provider can customize predetermined alert preferences for a customer service request with additional compensation offerings.

If a match is not found, the mapping server notifies the customer and/or the service provider with suggestions of preferences that needed to be adjusted based on pre-stored data of the customer requests and the service providers in the first database and/or the second database.

The customer and/or the service provider shares a pre-determined number of counteroffers for the other party wherein the system can limit the number of counters offers each of the customer and/or each of the service provider can submit, wherein the system also can have different limits for each of customers or each of service providers.

Anytime a customer or a service provider sharing their preferences with the mapping server, the mapping server makes real-time suggestions for parameters as they are being entered based on the data stored in the first database and/or the second database. The suggestions are just to inform a customer or a service provider that, the server has a customer service request for a service provider if the service provider is willing to adjust suggested parameters to the suggested parameters Or to inform a customer that, the server has at least a service provider that can fulfill the customer service request if the customer is willing to adjust the parameters suggested by the mapping server.

The mapping server uses tracking server data to track potential service providers that can fulfill a customer request, alerts one or more potential service providers, if the customer service request is not accepted or declined, then the mapping server identifies few more potential service providers that potentially can fulfill the customer service request Or the mapping server sends alerts to multiple potential service providers at the same time and whichever accepts it first, takes responsibility to fulfill the customer service request. The mapping server tracks the location of the service provider and finds a service provider that can fulfill a customer service request most efficiently and/or most effectively, alerts the service provider. The customer preferences also can prefer a service provider that is closest or can fulfill the service request most efficiently and time efficiently. The customer preference may limit proximities of a service provider to be alerted if a service request is on urgency such as a customer request a car jump start service, the customer may limit only service providers within 1 mile to be alerted or the mapping server can also make that decision based on the urgency of the customer for the service request to be fulfilled. The customer also can have an option to notified all service provider urgently if wishes and the customer may need to pay a premium to do so but in urgency, it's well worth it because if a customer needed to be somewhere and a car needs a flat tire replaced, the customer may pay a premium to get the job done promptly and a service provider will happily do it because of the additional premium he/she will be paid to fulfill.

The service provider may serve as a delivery person for an item that needs to be delivered from a store/one geographical location to an address/at least another geographical location, wherein the amount being offered for the delivery is automatically tied, by the mapping server, with the additional time/distance which in this case will be a trip from a current location of the service provider to the store/the one geographical location to the address/the at least another geographical location to back to the current location. This entire cycle will help the service provider make wiser decisions if a delivery job is worth taking or not. The service provider shares preferences for the total additional time/total additional travel distance preferred to fulfill one of the delivery services and alerted only if the service provider set preferences and preferred cost matches with the total additional travel time/the total additional travel distance (estimates based on traffic/route availabilities). In this case, the additional travel time/additional distance for the same delivery request will be different for at least two service providers with different GPS (current) locations, wherein each of the two service providers can make a decision more cost-efficiently. It might be worth doing delivery for one service provider who is closer to pickup/delivery location than another service provider who is out of route and will not make up for the time or distance needed to be traveled.

A mapping server may also use more than one service provider to fulfill one customer service request, wherein the first service provider fulfills part of the customer service request and at least a second service provider fulfills a part of the same customer service request.

The monitor server gets information on the internet from available resources for weather, current traffic, anticipated traffic for a future schedule, tracks a tracking number or a plane, and tracks a public or private transportation status. The monitor server alerts a customer about changes through the mapping server as per the customer set preferences. For ex. The monitor server alerts the customer if it's going to snow and asks if the customer needs snow cleaning service. The customer puts a request for a snow cleaning service at a customer preferred cost/range or accepts an offered cost by the mapping server to the customer, wherein the mapping server then notifies at least a service provider with a list of the geographical areas that accepted a snow cleaning service. The customer/mapping server pays in advance OR Once the snow cleaning services are fulfilled, the mapping server arranges the payments or the service provider accepts cash payments from customers directly. A similar setup can be used for landscaping, with alerts being sent or asking a customer to set preferences for a lawn care at the beginning of summer asking for lawn care subscriptions, etc.

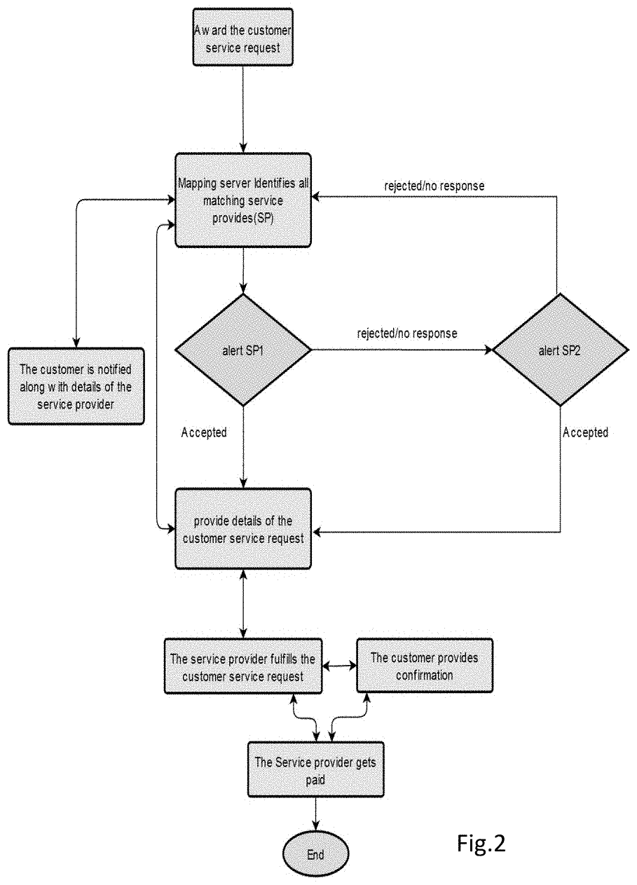

FIG. 2 illustrates a process of awarding a customer service request to a service provider, wherein a mapping server identifies at least a service provider or multiple service providers and sends requests to the service providers or the multiple services provides, and repeats the cycle if none of the service providers accepts the customer service request. If one of the service providers accepts the customer service request then that service provider is provided details of the customer service request and the customer is notified with the updates with information of the service provider that has accepted the customer service request. The service provider fulfills the customer service requests and gets paid.

If a customer preferred cost is higher than a service provider preferred cost, then the mapping server either offers the customer preferred cost to the service provider, or offers the service provider cost (which is lower in this case), or makes an offer based on circumstances and availability of other service providers in the area. A subscription-based model also can be established wherein subscribed customer gets a lower rate of both a customer preferred cost and a service provider preferred cost.

A service provider shares preference wherein the service provider sets a preferred total additional time/additional distance he/she can allocate, wherein the mapping service provider alerts the service provider with only at least a service that does not surprise the total additional time/the additional distance he/she can allocate.

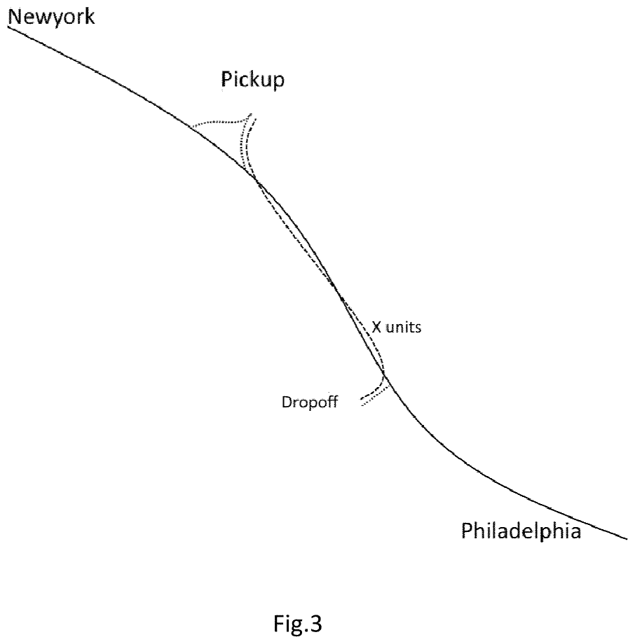

FIG. 3 illustrates a service provider of the preferred routes from one GPS location (New York) to another GPS location (Philadelphia). The service provider sets preferences wherein the pickup and drop-off locations (shown with dotted lines) adds additional travel time and additional travel distance to the preferred route. The service provider sets a preferred cost for the additional travel time/travel distance and gets notified if criteria are met. The service provider additionally also may set a pre-determined cost for each of the distance units/additional travel time to travel between the pickup and drop-off locations (shown with dashed lines with X as distance/travel time between the two). The mapping server allows the service provider to set preferences to calculate charges for the total of each of the distance units/additional travel time between two locations of pickup and the drop-off and add the service provider preferred cost for the total additional travel time/travel distance from the preferred route of travel. The service provider can also set preferences to ignore per each of the distance unit charge calculations and sets preferences for additional time/additional distance from the preferred route only. The mapping server may calculate, and add per distance unit charge on top of the service provider preferred charges for the additional travel time/additional travel distance. The mapping server also can calculate the total amount being offered for fulfilling the service request and coupling it with the service provider preferred parameters for a total of the additional time and/or the additional distance and/or the distance between the pickup and drop-off locations. The mapping server may use data from the monitor server and tracking server and recommend appropriate route availability that satisfied the service provider set route preferences and enables fulfillment of the customer service request efficiently with minimal hassled for the service provider. Additionally, a mapping server can be configured to alert a preferred service provider only for a customer service request with an additional travel time and/or an additional travel distance to be fulfilled is less than the travel time and/or the travel distance between two GPS locations of the preferred service provider. A mapping server can be configured to increase a service provider preferred cost based on additional travel time/additional travel distance to fulfill the customer service request. The mapping server also can be configured to allow a service provider set equations of a preferred cost in relation to additional travel time/additional travel distance during the scheduled trip.

A mapping server can be configured to send an alert based on, “a pre-determined additional travel distance should be less than the travel distance of the original scheduled trip between the at least two GPS locations;

So the travel distance between two GPS locations of the original trip should be >additional travel distance to fulfill the service request.
&
A mapping server can be configured to send an alert based on, “a pre-determined additional travel time should be less than the travel time of the original scheduled trip between the at least two GPS locations.
So the travel time between two GPS locations of the original trip should be >additional travel time to fulfill the service request.

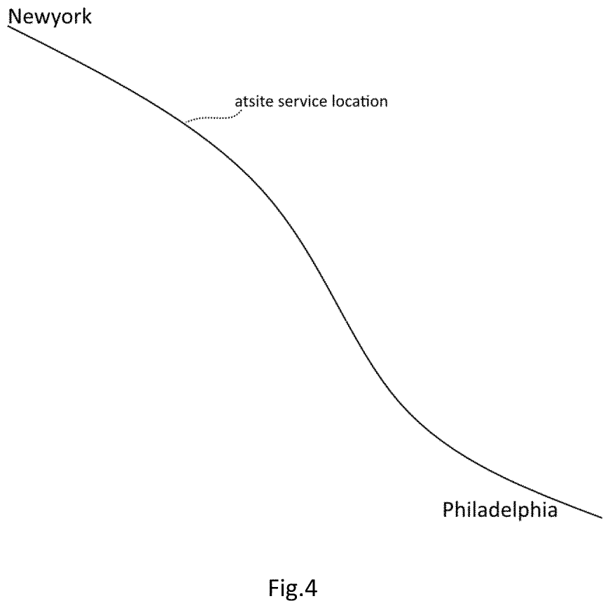

FIG. 4 illustrates a service provider's planned trip details between one GPS location (New York City) to another GPS location (Philadelphia) and a geographical location for an onsite customer service request. The service provider shares a service provider preferred cost for additional travel time/travel distance to fulfill the at site customer service request. The service provider also may charge a flat cost based on the nature of the onsite customer service request additionally on top of the service provider's preferred cost. The onsite service may be a customer needing a jump start or a flat tire replaced or a gas or any service that can be fulfilled at a site. Based on the urgency of the customer, the alerts can be configured to be sent to multiples of service providers. Additionally, a mapping server can be configured to alert a preferred service provider only for a customer onsite service request with an additional travel time and/or an additional travel distance to be fulfilled is less than the travel time and/or the travel distance between two GPS locations of the preferred service provider. A mapping server can be configured to increase a service provider preferred cost based on additional travel time/additional travel distance to fulfill the customer service request. The mapping server also can be configured to allow a service provider set equations of a preferred cost in relation to additional travel time/additional travel distance during the scheduled trip.

A mapping server can be configured to send an alert based on, “a pre-determined additional travel distance should be less than the travel distance of the original scheduled trip between the at least two GPS locations

So the travel distance between two GPS locations of the original trip should be >additional travel distance to fulfill the service request.
&
A mapping server can be configured to send an alert based on, “a pre-determined additional travel time should be less than the travel time of the original scheduled trip between the at least two GPS locations.
So the travel time between two GPS locations of the original trip should be >additional travel time to fulfill the service request.

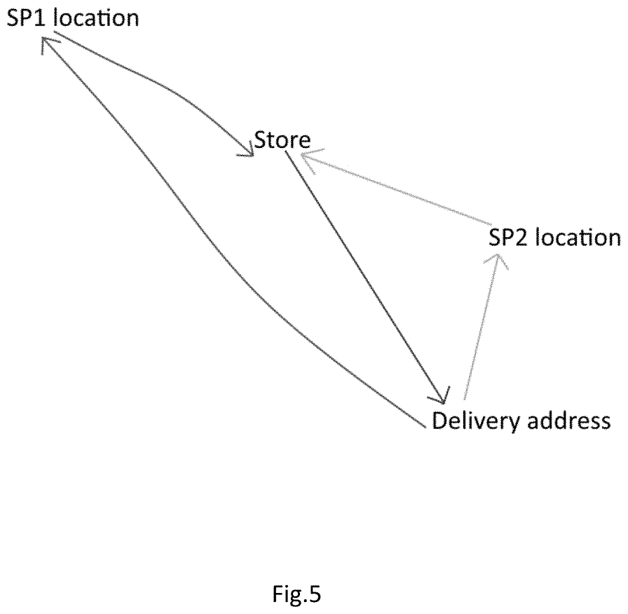

FIG. 5 illustrates a delivery service from a store to a delivery address. In this embodiment, two service providers are illustrated as SP1 and SP2. Each of the service providers shares their current locations along with their preferences for total additional time (to reach to store, deliver, and back to origin) and a preferred cost for it. Based on the preferences set by SP1 and SP2, they both receive different breakdowns of total distance needs to be traveled (based on the location of each of the SP1 and SP2+route availability+traffic for the entire trip); total travel time required (based on the location of each of the SP1 and SP2 +route availability+traffic for the entire trip) to fulfill the delivery service and offered amount. The service providers SP1 and SP2 set preferences for total trip distance/total trip time in conjunction with the offered amount for the delivery service. Even with the same preferences set by both SP1 and SP2, the mapping server based on locations and other predetermined parameters singles out the best location of an ideal service provider to fulfill the delivery services. The parameters include but are not limited to each of the service providers' set preferences, available routes, and traffic on those available routes from the location of each of the service providers and determine the ideal service provider to fulfill the delivery service request. If a delivery service request alert is rejected or ignored by one service provider then the mapping server repeats the cycle until it finds a service provider that can fulfill the delivery service request. Each of the SP1 and SP2 also can set preferences wherein if the offered amount is not worth the total time/distance of the trip, one will not be alerted. The additional travel time/distance from the current location to the store and from the delivery address back to origin helps the service provider make wiser and profitable decisions. Also, each of the service providers gets alerts based on their current locations because if the service providers are not making money, they will discontinue providing delivery services anytime. This method helps manage the distribution of delivery services better. Additionally, a mapping server can be configured to alert a preferred service provider only for a delivery service request with an additional travel time being less than a travel time between the origin and the pickup location OR the travel time between the drop off location and the origin. Additionally, a mapping server can be configured to alert a preferred service provider only for a delivery service request with an additional travel distance being less than a travel distance between the origin and the pickup location OR the travel distance between the drop off location and the origin, wherein the additional travel distance or additional travel time is from pickup location to drop off (delivery) location.

A mapping server can be configured to send an alert based on, “a pre-determined additional travel distance (from origin to pick up location+drop-off location to origin) should not exceed twice of the travel distance between the pickup location and the drop-off location.

so
Additional travel distance to and from the delivery service location <twice of the travel distance between the pickup location and the drop-off location.
&

A mapping server can be configured to send an alert based on, “a pre-determined additional travel time (from origin to pick up location+drop-off to origin) should not exceed the twice of the travel time between the pickup location and the drop-off location.

so
Additional travel time to and from the delivery service locations <twice of the travel time between the pickup location and the drop-off location.

1. A method of mapping preferences, the method comprising:
a) receiving at least a customer configured preferences including the customer preferred cost for at least a customer service request associated with a plurality of schedule service times with at least two geographical locations;
b) generating a first database indicating each of the customer configured preferences;
c) receiving at least a driver configured preferences including at least a scheduled trip details, the scheduled trip details including a schedule associated with at least two GPS locations, and the driver preferred cost for the driver pre-determined acceptable change in the trip details to fulfill the driver preferred at least a service;
wherein the driver configured preferences are adjustable by the driver, wherein the acceptable change in the trip details is an additional travel time and a change in the schedule between the two GPS locations, wherein a set of the additional travel time and the change in the schedule to fulfill the driver preferred at least the service during the scheduled trip between the two GPS locations determines the driver preferred cost;
d) generating a second database indicating each of the driver configured preferences;
e) mapping the first database and the second database to generate the set of the additional travel time and the change in the schedule to fulfill the driver preferred set of services during the scheduled trip between two GPS locations based on the driver preferred cost to fulfill the customer preferred cost for the service request;
f) alerting the driver with details of the set of the additional travel time, the change in the schedule to fulfill the customer service request at the plurality of schedule service times and the customer preferred cost.

2. The method of mapping preferences of claim 1, wherein the customer configured preferences including at least one of the following:
a) a rating preferences for a preferred driver;
b) a range of the customer preferred cost in conjunction with one of the service schedule times and/or one of the at least two geo-graphical locations and/or a preferred service provider review ratings and/or a location sharing preferences of a preferred service provider and/or a picture preferences and/or a distance between the geographical locations of the customer service request;
c) a vehicle type and/or a vehicle capacity of a preferred driver;
d) an additional compensation preferences for at least a pre-determined parameter;
e) a payment preferences;
f) preference to use a plurality of the drivers to fulfill the customer service request;
g) the customer preferred cost in conjunction with a pre-determined parameters for a preferred driver;
h) the customer preferred cost tied up with a preferred review rating preferences of a preferred driver, wherein the customer preferred cost is offered for a preferred review rating or a preferred range of review ratings;
i) to be notified in advance as the driver advances near one of the at least two geographical locations.

3. The method of mapping preferences of claim 1, wherein the driver configured parameters including at least one of the following:
a) more than one set of the driver preferred cost for the additional travel time and change in the schedule and/or a preferred review rating of the customer and/or a driver selected geographical area of preference and/or a vehicle or transportation vehicle and/or a transportation method preferences and/or a route preference;
b) a preferred review rating for at least a preferred customer;
c) a location sharing preferences;
d) a vehicle or transportation vehicle and/or method preferences;
e) a route preference;
f) a multiple service request preferences.

4. The method of mapping preferences of claim 1, wherein the mapping server system makes real time recommendations to the customer or the driver while the customer or the driver is sharing preferences to the mapping server, wherein the mapping server makes recommendations based on the existing data of the first database or the second database, wherein the recommendations are made to inform the customer or the driver to adjust preferences.

5. The method of mapping preferences of claim 1, wherein the mapping server system alerts the customer or the driver suggesting parameters to be modified if no match is found.

6. The method of mapping preferences of claim 1, wherein one of the at least two GPS locations of the driver is a current real time location of the driver or both of the at least two GPS locations of the driver are geographically the same location.

7. The method of mapping preferences of claim 1, wherein the driver scheduled trip details is shared by a navigation application of an internet enabled device with the mapping server system.

8. A method of mapping preferences, the method comprising:
a) receiving at least a customer configured preferences including the customer preferred cost for at least a customer service request associated with a plurality of schedule service times with at least a geographical location;
b) generating a first database indicating each of the customer configured preferences;
c) receiving at least a driver configured preferences including at least a scheduled trip details, the scheduled trip details including a schedule associated with at least two GPS locations, and the driver preferred cost for the driver pre-determined acceptable change in the trip details to fulfill the driver preferred at least a service;
wherein the driver configured preferences are adjustable by the driver, wherein the acceptable change in the trip details is an additional travel distance to at least a route of travel between the two GPS locations, wherein a set of the additional travel distance to fulfill the driver preferred at least the service during the scheduled trip between the two GPS locations determines the driver preferred cost;
d) generating a second database indicating each of the driver configured preferences;
e) mapping the first database and the second database to generate the set of the additional travel distance to fulfill the driver preferred at least the service during the scheduled trip between the two GPS locations based on the driver preferred cost to fulfill the customer preferred cost for the customer service request;
f) alerting the driver with details of the set of the additional travel distance to fulfill the customer service request at the plurality of schedule service times and the customer preferred cost.

9. The method of mapping preferences of claim 8, wherein the customer configured preferences including at least one of the following:
a) a rating preferences for a preferred driver;
b) a range of the customer preferred cost in conjunction with one of the service schedule times and/or one of the at least two geo-graphical locations and/or a preferred service provider review ratings and/or a location sharing preferences of a preferred service provider and/or a picture preferences and/or a distance between the geographical locations of the customer service request;
c) a vehicle type and/or a vehicle capacity of a preferred driver;
d) an additional compensation preferences for at least a pre-determined parameter;
e) a payment preferences;
f) preference to use a plurality of the drivers to fulfill the customer service request;
g) the customer preferred cost in conjunction with a pre-determined parameters for a preferred driver;
h) the customer preferred cost tied up with a preferred review rating preferences of a preferred driver, wherein the customer preferred cost is offered for a preferred review rating or a preferred range of review ratings;
i) to be notified in advance as the driver advances near one of the at least two geographical locations.

10. The method of mapping preferences of claim 8, wherein the driver configured parameters including at least one of the following:
a) more than one set of the driver preferred cost for the additional travel time and change in the schedule and/or a preferred review rating of the customer and/or a driver selected geographical area of preference and/or a vehicle or transportation vehicle and/or method preferences and/or a route preference;
b) a preferred review rating for at least a preferred customer;
c) a location sharing preferences;
d) a vehicle or transportation vehicle and/or method preferences;
e) a route preference;
f) a multiple service request preferences.

11. The method of mapping preferences of claim 8, wherein the mapping server system makes real time recommendations to the customer or the driver while the customer or the driver is sharing preferences to the mapping server, wherein the mapping server makes recommendations based on the existing data of the first database or the second database, wherein the recommendations are made to inform the customer or the driver to adjust preferences.

12. The method of mapping preferences of claim 8, wherein the mapping server system alerts the customer or the driver suggesting parameters to be modified if no match is found.

13. The method of mapping preferences of claim 8, wherein one of the at least two GPS locations of the driver is a current real time location of the driver or both of the at least two GPS locations of the driver are geographically the same location.

14. The method of mapping preferences of claim 8, wherein the driver scheduled trip details is shared by a navigation application of an internet enabled device with the mapping server system.

15. A method of mapping preferences, the method comprising:
a) receiving at least a customer configured preferences including the customer preferred cost for at least a service request associated with a plurality of schedule service times with at least a geographical location;
b) generating a first database indicating each of the customer configured preferences;
c) receiving at least a service provider configured preferences including at least a scheduled trip details, the scheduled trip details including a schedule associated with at least two GPS locations, and the service provider preferred cost for the service provider pre-determined acceptable change in the trip details to fulfill the service provider preferred at least a service;
wherein the service provider configured preferences are adjustable by the service provider, wherein the acceptable change in the trip details is an additional travel time and/or an additional travel distance to at least a route of travel between the two GPS locations, wherein a set of the additional travel time and/or the additional travel distance to the route of travel between the two GPS locations determines the service provider preferred cost;
d) generating a second database indicating each of the service provider configured preferences;
e) mapping the first database and the second database to generate the set of the additional travel time and/or the additional travel distance to the route of travel between the two GPS locations based on the service provider preferred cost to fulfill the customer preferred cost for the customer service request;
f) alerting the service provider with details of the set of the additional travel time and/or the additional travel distance to the route of travel to fulfill the customer service request at the plurality of schedule service times and the customer preferred cost.

16. The method of mapping preferences of claim 15, wherein the customer configured preferences including at least one of the following:
a) a rating preferences for a preferred service provider;
b) a range of the customer preferred cost in conjunction with one of the service schedule times and/or one of the geo-graphical location and/or a preferred service provider review ratings and/or a location sharing preferences of a preferred service provider and/or a picture preferences;
c) a vehicle type and/or a vehicle capacity of a preferred service provider;
d) an additional compensation preferences for at least a pre-determined parameter;
e) a payment preferences;
f) preference to use a plurality of the service providers to fulfill the customer service request;
g) the customer preferred cost in conjunction with a pre-determined parameters for a preferred service provider;
h) the customer preferred cost tied up with a preferred review rating preferences of a preferred service provider, wherein the customer preferred cost is offered for a preferred review rating or a preferred range of review ratings;
i) to be notified in advance as the service provider advances near one of the geographical locations.

17. The method of mapping preferences of claim 15, wherein the service provider configured parameters including at least one of the following:
a) more than one set of the service provider preferred cost for the additional travel time and/or additional travel distance change in the schedule and/or a preferred review rating of the customer and/or a service provider selected geographical area of preference and/or a vehicle or transportation vehicle and/or a transportation method preferences and/or a route preference;
b) a preferred review rating for at least a preferred customer;
c) a location sharing preferences;
d) a vehicle or transportation vehicle and/or method preferences;
e) a route preference;
f) a multiple service request preferences;
g) a geographical area of preference.

18. The method of mapping preferences of claim 15, wherein the mapping server system makes real time recommendations to the customer or the service provider while the customer or the service provider is sharing preferences to the mapping server, wherein the mapping server makes recommendations based on the existing data of the first database or the second database, wherein the recommendations are made to inform the customer or the driver to adjust preferences.

19. The method of mapping preferences of claim 15, wherein the mapping server system alerts the customer or the service provider suggesting parameters to be modified if no match is found.

20. The method of mapping preferences of claim 15, wherein one of the at least two GPS locations of the service provider is a current real time location of the service provider or both of the at least two GPS locations of the service provider's are geographically the same location.

21. The method of mapping preferences of claim 15, wherein the service provider scheduled trip details is shared by a navigation application of an internet enabled device with the mapping server system.

22. The method of mapping preferences of claim 15, wherein the service provider uses a public or a private transportation for at least a part of the scheduled trip.

23. The method of mapping preferences of claims 15, wherein the service provider is configured to recommend the customer service request with the additional travel time and/or the additional travel distance, to fulfill the customer service request, is less than a travel time and/or a travel distance between the two GPS locations of the scheduled trip.

24. A method of mapping preferences, the method comprising:
a) receiving at least a customer configured preferences including the customer preferred cost for at least a customer service request associated with only one geographical location;
b) generating a first database indicating each of the customer configured preferences in a real time;
c) receiving at least a service provider configured preferences including a real time GPS location information of the service provider, the service provider preferred cost for at least a preferred service and a preferred proximity of the preferred service in relationship from the real-time GPS location information;
wherein the service provider configured preferences are adjustable by the service provider, wherein a set of the preferred service and the preferred proximity of the preferred service determines the service provider preferred cost;
d) generating a second database indicating each of the service provider configured preferences with the real time GPS location information of each of the service provider respectively;
e) mapping the first database and the second database to generate the set of the preferred service and the preferred proximity of the preferred service determines the service provider preferred cost to fulfill the customer preferred cost for the customer service request;
f) alerting the service provider with details of the set of the preferred service and a proximity of the customer service request at the customer preferred cost.

25. The method of mapping preferences of claim 24, wherein the at least a customer configured preferences including at least one of the following:
a) preferences for a preferred service provider that includes a rating preferences for a preferred service provider and/or a location sharing preferences of a preferred service provider and/or service schedule times of a preferred service provider and/or proximity to the one geographical location and/or a certification requirement and/or a preferred category and/or a payment preferences of a preferred service provider and/or a picture preferences of a preferred service provider;
b) a range of the customer preferred cost in conjunction with a preferred service provider review rating and/or a proximity to the one geographical location and/or a certification of the service provider and/or a payment preferences of a preferred service provider and/or a location sharing preferences of a preferred service provider
c) an additional compensation preferences based on pre-determined criteria of the customer;
d) the customer preferred cost tied up with a preferred review rating preferences of a preferred service provider, wherein the customer preferred cost is offered for a preferred review rating or a preferred range of review ratings;
e) to be notified in advance as the service provider advances near one of the geographical locations.

26. The method of mapping preferences of claim 24, wherein the service provider configured parameters including at least one of the following:
a) more than one set of the service provider preferred cost for the additional travel time and/or additional travel distance and/or a preferred review rating of the customer and/or the service provider selected geographical area of preference and/or a vehicle or transportation vehicle and/or a transportation method preferences and/or a route preference;
b) a preferred review rating for at least a preferred customer;
c) a location sharing preferences;
d) a vehicle or transportation vehicle and/or method preferences;
e) a route preference;
f) a multiple service request preferences;

27. The method of mapping preferences of claim 24, wherein the mapping server system makes real time recommendations to the customer or the service provider while the customer or the service provider is sharing preferences to the mapping server, wherein the mapping server makes recommendations based on the existing data of the first database or the second database, wherein the recommendations are made to inform the customer or the driver to adjust preferences.

28. The method of mapping preferences of claim 24, wherein the system alerts the at least a customer to modify the at least a customer configured preferences or the at least a service provider to modify the at least a driver configured preferences if no match is found.

29. The method of mapping preferences of claim 24, wherein the service provider is alerted with an on-site customer service requests with the one geographical location being within the preferred proximity of the service provider.

30. The method of mapping preferences of claim 24, wherein the mapping server alerts the service provider with a closest proximity to the one geographical location.
